(19) United States
(12) Patent Application Publication
(10) Pub. No.: US 2019/0087236 A1
(43) Pub. Date: Mar. 21, 2019

(54) RESOURCE SCHEDULING DEVICE, SYSTEM, AND METHOD

(71) Applicant: ZHENGZHOU YUNHAI INFORMATION TECHNOLOGY CO., LTD., Zhengzhou, Henan (CN)

(72) Inventor: Tao LIU, Zhengzhou, Henan (CN)

(73) Assignee: ZHENGZHOU YUNHAI INFORMATION TECHNOLOGY CO., LTD., Zhengzhou, Henan (CN)

(21) Appl. No.: 16/097,027

(22) PCT Filed: Jul. 20, 2017
(86) PCT No.: PCT/CN2017/093685

§ 371 Date: Oct. 26, 2018

(30) Foreign Application Priority Data
Dec. 13, 2016 (CN) 201611146442.2

(51) Int. Cl. G06F 9/50; G06F 9/48

(52) U.S. Cl. CPC G06F 9/5083; G06F 9/5038; G06F 9/4881

(57) ABSTRACT

A resource scheduling device, system, and method are provided. The device includes: a data link interaction module and a dynamic resource control module. The data link interaction module is connected to an external server, at least two external processors, and the dynamic resource control module. The dynamic resource control module is connected to the external server, and is configured to monitor a task amount of a to-be-allocated task carried by the external server, generate, based on the task amount, a route switching instruction, and transmit the instruction to the data link interaction module. The data link interaction module is configured to receive the to-be-allocated task allocated by the external server and the route switching instruction transmitted by the dynamic resource control module and transmit, in response to the instruction, the to-be-allocated task to at least one target processor.

### FIELD

The present disclosure relates to the technical field of computers, and particularly to a resource scheduling device, a resource scheduling system and a resource scheduling method.

### BACKGROUND

Pooled computing resources, as a new centralized computing system, have been gradually used to execute complicated computing tasks. Computing resource scheduling becomes increasingly important, in order for equalized and effective usage of the computing resources.

At present, the computing resources are scheduled over a network. The computing nodes are connected to a scheduling center over the network, that is, the scheduling center schedules resources of the computing nodes over the network. In a case that data transmission is performed over the network, large delay for scheduling the computing resources may be caused due to a limited bandwidth of the network.

### SUMMARY

A resource scheduling device, a resource scheduling system and a resource scheduling method are provided according to the embodiments of the present disclosure, to effectively reduce delay for resource scheduling.

A resource scheduling device is provided in a first aspect, which includes a data link interacting module and a dynamic resource controlling module. The data link interacting module is connected to an external server, at least two external processors and the dynamic resource controlling module. The dynamic resource controlling module is connected to the external server, and is configured to monitor a task amount of a to-be-allocated task carried by the external server, generate a route switching instruction based on the task amount, and transmit the route switching instruction to the data link interacting module. The data link interacting module is configured to receive the to-be-allocated task allocated by the external server and the route switching instruction transmitted by the dynamic resource controlling module, and transmit the to-be-allocated task to at least one target processor among the at least two external processors in response to the route switching instruction.

Preferably, the data link interacting module includes a first FGPA chip, a second FPGA chip and a x16 bandwidth PCIE bus. The first FPGA chip is configured to switch one channel of the x16 bandwidth PCIE bus to four channels. The second FPGA chip is configured to switch the four channels to sixteen channels, and connect each channel of the sixteen channels to one of the external processors. The dynamic resource controlling module is connected to the second FGPA chip, and is configured to transmit the route switching instruction to the second FPGA chip. The second FPGA chip is configured to select at least one task transmission link from the sixteen channels in response to the route switching instruction, and transmit the to-be-allocated task to the at least one target processor corresponding to the at least one task transmission link through the at least one task transmission link.

Preferably, the dynamic resource controlling module includes a calculating sub module and an instruction generating sub module. The calculating sub module is configured to determine computing capacity of each of the external processors, and calculate the number of the target processors based on the computing capacity of each of the external processors and the monitored task amount. The instruction generating sub module is configured to obtain a usage state of each of the processors provided by the external server, and generate the route switching instruction based on the usage state of each of the processors and the number of the target processors calculated by the calculating sub unit.

Preferably, the calculation sub module is further configured to calculate the number of the target processors according to a calculation equation as follows:

$$Y = ⌈ \frac{M}{N} ⌉$$

where Y denotes the number of the target processors, M denotes the task amount, and N denotes the computing capacity of each of the external processors.

Preferably, the dynamic resource controlling module is further configured to monitor a priority level of the to-be-allocated task carried by the external server, and transmit a suspending instruction to the data link interacting module in a case that the priority level of the to-be-allocated task is higher than a priority level of a currently run task. The data link interacting module is further configured to suspend processing of the external processor for the currently run task upon receiving the suspending instruction, and transmit the to-be-allocated task to the at least one target processor.

A resource scheduling system is provided in a second aspect, which includes the resource scheduling device described above, a server and at least two processors. The server is configured to receive a to-be-allocated task inputted, and the resource scheduling device is configured to allocate the to-be-allocated task to at least one target processor among the at least two processors.

Preferably, the server is further configured to determine usage states of the at least two processors, and transmit the usage states of the at least two processors to the resource scheduling device. The resource scheduling device is configured to generate a route switching instruction based on the usage states of the at least two processors, and allocate the to-be-allocated task to at least one target processor among the at least two processors in response to the route switching instruction.

Preferably, the server is further configured to mark a priority level of the to-be-allocated task. The resource scheduling device is configured to obtain the priority level of the to-be-allocated task marked by the server. In a case that the marked priority level of the to-be-allocated task is higher than a priority level of a currently run task processed by the processor, the resource scheduling device is configured to suspend processing of the processor for the currently run task and allocate the to-be-allocated task to the processor.

A resource scheduling method is provided in a third aspect, which includes: monitoring, by a dynamic resource controlling module, a task amount of a to-be-allocated task carried by an external server; generating a route switching instruction based on the task amount, and transmitting the route switching instruction to a data link interacting module; and transmitting, by the data link interacting module, the to-be-allocated task to at least one target processor in response to the route switching instruction.

Preferably, the above method further includes: determining, by the dynamic resource controlling module, computing capacity of each of processors. After the monitoring the task amount of the to-be-allocated task carried by the external server and before the generating the route switching instruction, the method further includes: calculating the number of the target processors based on the computing capacity of each of the external processors and the monitored task amount, and obtaining a usage state of each of the processors provided by the external server. The generating the route switching instruction includes: generating the route switching instruction based on the usage state of each of the processors and the calculated number of the target processors.

Preferably, the calculating the number of the target processors includes: calculating the number of the target processors according to a calculation equation as follows:

$$Y = ⌈ \frac{M}{N} ⌉$$

where Y denotes the number of the target processors, M denotes the task amount, and N denotes the computing capacity of each of the external processors.

A resource scheduling device, a resource scheduling system and a resource scheduling method are provided according to the embodiments of the present disclosure. A data link interacting module is connected to an external server, at least two external processors and a dynamic resource controlling module. The dynamic resource controlling module is connected to the external server, and is configured to monitor a task amount of a to-be-allocated task carried by the external server, generate a route switching instruction based on the task amount, and transmit the route switching instruction to the data link interacting module. The data link interacting module is configured to receive the to-be-allocated task allocated by the external server and the route switching instruction transmitted by the dynamic resource controlling module, and transmit the to-be-allocated task to at least one target processor in response to the route switching instruction. A process of allocating the task to the processor is implemented by the data link interacting module, and the data link interacting module is connected to the server and the processors, so that a task and a task calculation result are transmitted between the server and the processor without data sharing over a network, thereby effectively reducing delay for resource scheduling.

### BRIEF DESCRIPTION OF THE DRAWINGS

In order to more clearly illustrate the technical solution according to the embodiments of the present disclosure or the conventional technology, the drawings required in description for the embodiments or the conventional technology are described simply. Apparently, the drawings described below show some embodiments of the present disclosure. For those skilled in the art, other drawings can also be obtained based on the drawings without creative work.

FIG. 1 is a schematic structural diagram of a resource scheduling device according to an embodiment of the present disclosure;

FIG. 2 is a schematic structural diagram of a resource scheduling device according to another embodiment of the present disclosure;

FIG. 3 is a schematic structural diagram of a resource scheduling device according to another embodiment of the present disclosure;

FIG. 4 is a schematic structural diagram of a resource scheduling system according to an embodiment of the present disclosure;

FIG. 5 is a flow chart of a resource scheduling method according to an embodiment of the present disclosure;

FIG. 6 is a schematic structural diagram of a resource scheduling system according to another embodiment of the present disclosure; and

FIG. 7 is a flow chart of a resource scheduling method according to another embodiment of the present disclosure.

### DETAILED DESCRIPTION OF THE EMBODIMENTS

In order to make the objective, the technical solutions and the advantages of the embodiments of the present disclosure clearer, the technical solutions in the embodiments of the present disclosure are described clearly and completely in conjunction with the drawings in the embodiments of the present disclosure hereinafter. Apparently, the described embodiments are a part rather than all of the embodiments of the present disclosure. All other embodiments acquired by those skilled in the art based on the embodiments of the present disclosure without creative work fall within the protection scope of the present disclosure.

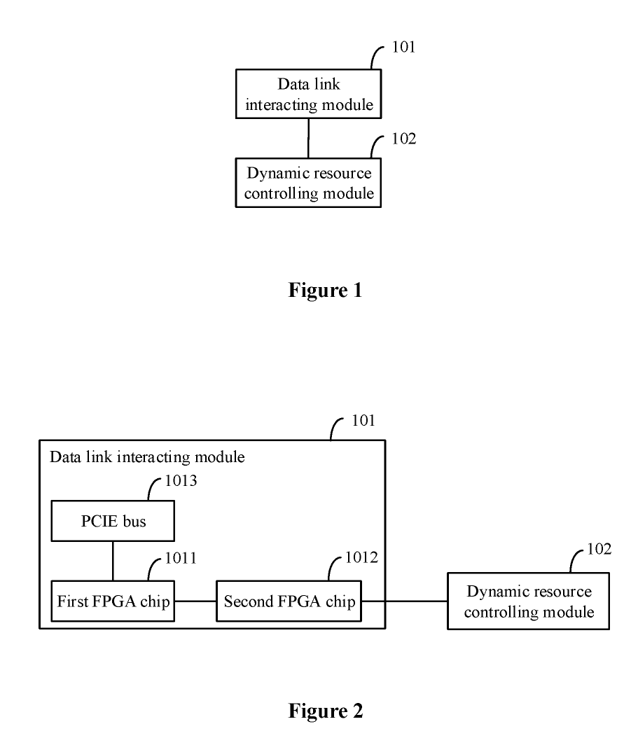

As shown in FIG. 1, a resource scheduling device is provided according to an embodiment of the present disclosure. The resource scheduling device may include a data link interacting module 101 and a dynamic resource controlling module 102.

The data link interacting module 101 is connected to an external server, at least two external processors and the dynamic resource controlling module 102.

The dynamic resource controlling module 102 is connected to the external server, and is configured to monitor a task amount of a to-be-allocated task carried by the external server, generate a route switching instruction based on the task amount, and transmit the route switching instruction to the data link interacting module 101.

The data link interacting module 101 is configured to receive the to-be-allocated task allocated by the external server and the route switching instruction transmitted by the dynamic resource controlling module 102, and transmit the to-be-allocated task to at least one target processor in response to the route switching instruction.

In the embodiment shown in FIG. 1, the dynamic resource controlling module is connected to the external server, and is configured to monitor a task amount of a to-be-allocated task carried by the external server, generate a route switching instruction based on the task amount, and transmit the route switching instruction to the data link interacting module. The data link interacting module is configured to receive the to-be-allocated task allocated by the external server and the route switching instruction transmitted by the dynamic resource controlling module, and transmit the to-be-allocated task to at least one target processor in response to the route switching instruction. A process of allocating a task to the processor is implemented by the data link interacting module, and the data link interacting module is connected to the server and the processor, so that a task and a task calculation result are transmitted between the server and the processor without data sharing over a network, thereby effectively reducing delay for resource scheduling.

As shown in FIG. 2, in another embodiment of the present disclosure, the data link interacting module 101 includes a first FPGA chip 1011, a second FPGA chip 1012 and a x16 bandwidth PCIE bus 1013.

The first FPGA chip 1011 is configured to switch one channel of the x16 bandwidth PCIE bus 1013 to four channels.

The second FPGA chip 1012 is configured to switch the four channels to sixteen channels, and connect each of the sixteen channels to one of the external processors.

The dynamic resource controlling module 102 is connected to the second FPGA chip 1012, and is configured to transmit the route switching instruction to the second FPGA chip 1012.

The second FPGA chip 1012 is configured to select at least one task transmission link from the sixteen channels in response to the route switching instruction, and transmit the task to at least one target processor corresponding to the at least one task transmission link through the at least one task transmission link.

The above FPGA chip has multiple ports, and may be connected to the processor, other FPGA chip, a transmission bus and the dynamic resource controlling module through the ports. Each of the ports has a specific function, to implement data interaction.

For example, one end of the x16 bandwidth PCIE bus A is connected to the external server, and the other end of the x16 bandwidth PCIE bus A is connected to the first FPGA chip. One channel for the PCIE bus A is switched to four channels, that is, ports A1, A2, A3 and A4, through the first FPGA chip. Four channels corresponding to the ports A1, A2, A3 and A4 for the PCIE bus are switched to sixteen channels through the second FPGA chip, that is, downlink data interfaces A11, A12, A13, A14, A21, A22, A23, A24, A31, A32, A33, A34, A41, A42, A43 and A44 are formed, thereby implementing switching transmission of the x16 bandwidth PCIE bus from one channel to sixteen channels.

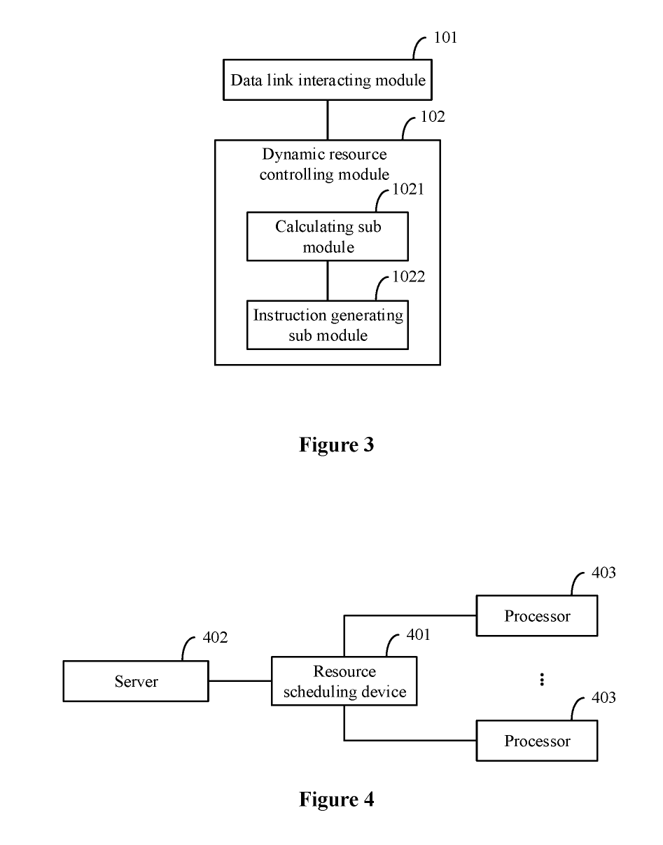

In another embodiment of the present disclosure, as shown in FIG. 3, the dynamic resource controlling module 102 includes a calculating sub module 1021 and an instruction generating sub module 1022.

The calculating sub module 1021 is configured to determine computing capacity of each of the external processors, and calculate the number of target processors based on the computing capacity of each of the external processors and the monitored task amount.

The instruction generating sub module 1022 is configured to obtain a usage state of each of the processors provided by the external server, and generate a route switching instruction based on the usage state of the processor and the number of the target processors calculated by the calculating sub unit 1021.

In another embodiment of the present disclosure, the calculating sub module is further configured to calculate the number of the target processors based on a calculation equation as follows:

$$Y = ⌈ \frac{M}{N} ⌉$$

in which, Y denotes the number of the target processors, M denotes the task amount, and N denotes the computing capacity of each of the external processors.

In another embodiment of the present disclosure, the dynamic resource controlling module 102 is further configured to monitor a priority level of the to-be-allocated task carried by the external server, and transmit a suspending instruction to the data link interacting module 101 in a case that the priority level of the to-be-allocated task is higher than a priority level of a currently run task.

The data link interacting module 101 is further configured to suspend processing of the external processor for the currently run task upon receiving the suspending instruction, and transmit the to-be-allocated task to at least one target processor.

In another embodiment of the present disclosure, the dynamic resource controlling module 102 includes an ARM chip.

As shown in FIG. 4, a resource scheduling system is provided according to an embodiment of the present disclosure, which includes the resource scheduling device 401 described above, a server 402 and at least two processors 403.

The server 402 is configured to receive a to-be-allocated task inputted, and allocate the to-be-allocated task to at least one target processor among the at least two processors 403 through the resource scheduling device 401.

In another embodiment of the present disclosure, the server 402 is further configured to determine usage states of the at least two processors, and transmit the usage states of the at least two processors to the resource scheduling device 401.

The resource scheduling device 401 is configured to generate a route switching instruction based on the usage states of the at least two processors, and allocate the to-be-allocated task to at least one target processor among the at least two processors 403 in response to the route switching instruction.

In another embodiment of the present disclosure, the server 402 is further configured to mark a priority level of the to-be-allocated task.

The resource scheduling device 401 is configured to obtain the priority level of the to-be-allocated task marked by the server 402. In a case that the marked priority level of the to-be-allocated task is higher than a priority level of a currently run task processed by the processor, the resource scheduling device 401 is configured to suspend processing of the processor for the currently run task, and allocate the to-be-allocated task to the processor.

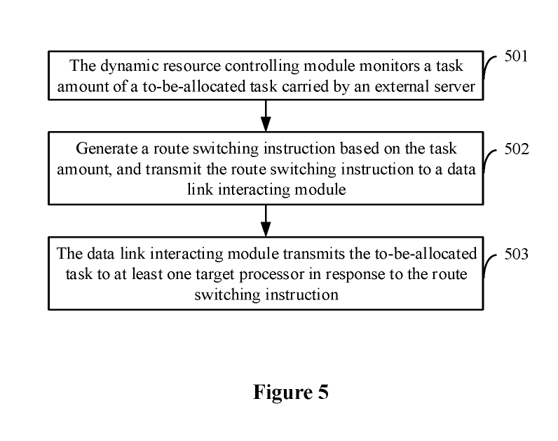

As shown in FIG. 5, a resource scheduling method is provided according to an embodiment of the present disclosure, the method may include steps 501 to 503.

In step 501, a task amount of a to-be-allocated task carried by an external server is monitored by a dynamic resource controlling module.

In step 502, a route switching instruction is generated based on the task amount, and the route switching instruction is transmitted to a data link interacting module.

In step 503, the data link interacting module transmits the to-be-allocated task to at least one target processor in response to the route switching instruction.

In an embodiment of the present disclosure, in order to ensure processing efficiency of the task, the above method further includes determining computing capacity of each of the processors by the dynamic resource controlling module. After step 501 and before step 502, the method further includes: calculating the number of target processors based on the computing capacity of each of the external processors and the monitored task amount, and obtaining a usage state of each of the processors provided by the external server. In the embodiment, step 502 includes generating a route switching instruction based on the usage state of the processors and the calculated number of the target processors.

In an embodiment of the present disclosure, the number of the target processors is calculated according to a calculation equation as follows.

$$Y = ⌈ \frac{M}{N} ⌉$$

in which, Y denotes the number of target processors, M denotes the task amount, and N denotes the computing capacity of each of the external processors.

In an embodiment of the present disclosure, in order to ensure that a task with a high priority level is processed preferentially, the above method further includes: monitoring, by the dynamic resource controlling module, a priority level of the to-be-allocated task carried by the external server; transmitting a suspending instruction to the data link interacting module in a case that the priority level of the to-be-allocated task is higher than a priority level of a currently run task; and upon receiving the suspending instruction, suspending processing of the external processor for the currently run task and transmitting the to-be-allocated task to at least one target processor, by the data link interacting module.

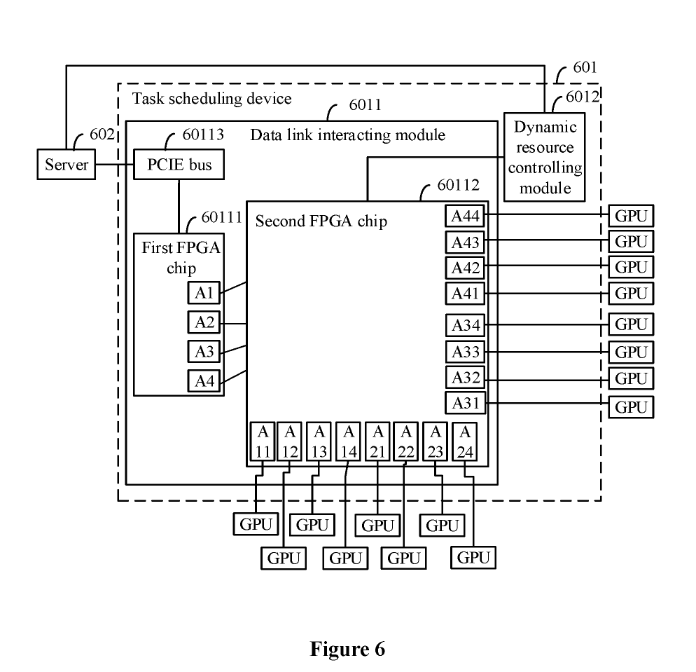

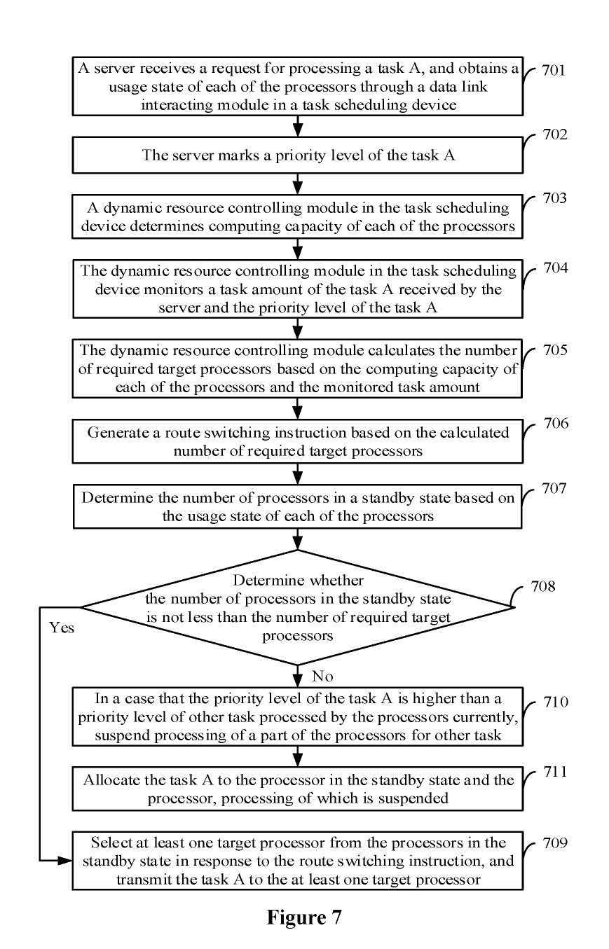

A case that a task A is processed by a resource scheduling system shown in FIG. 6 is taken as an example, for further illustrating the resource scheduling method. As shown in FIG. 7, the resource scheduling method may include steps 701 to 711.

In step 701, a server receives a request for processing a task A, and obtains a usage state of each of the processors through a data link interacting module in a task scheduling device.

As shown in FIG. 6, a server 602 is connected to a first FPGA chip 60111 through a x16 PCIE bus 60113 in the task scheduling device. The first FPGA chip 60111 is connected to a second FPGA chip 60112 through four ports A1, A2, A3 and A4, and each of sixteen ports A11, A12, A13, A14, A21, A22, A23, A24, A31, A32, A33, A34, A41, A42, A43 and A44 of the second FPGA chip 60112 is connected to one processor (GPU). That is, the server is mounted with sixteen processors (GPUs). The x16 PCIE bus 60113, the first FPGA chip 60111 and the second FPGA chip 60112 constitute the data link interacting module 6011 in the task scheduling device 601.

Since the server 602 is connected to sixteen GPUs through the data link interacting module 6011 in the task scheduling device 601, the server 602 obtains a usage state of each of the processors (GPUs) through the data link interacting module 6011 in step 701. The usage state may include a standby state, an operating state, and a task processed by the processor in the operating state.

In step 702, the server marks a priority level of the task A.

In this step, the server may mark a priority level of the task based on a type of the task. For example, in a case that the task A is a preprocessing task of a task B processed currently, the task A has a higher priority than the task B.

In step 703, a dynamic resource controlling module in the task scheduling device determines computing capacity of each of the processors.

In the task scheduling system shown in FIG. 6, the processors (GPUs) have the same computing capacity. For example, the computing capacity is 20 percent of CPU of the server.

In step 704, the dynamic resource controlling module in the task scheduling device monitors a task amount of the task A received by the server and the priority level of the task A.

As shown in FIG. 6, the dynamic resource controlling module 6012 in the task scheduling device 601 is connected to the server 602, and is configured to monitor a task amount of the task A received by the server 602 and the priority level of the task A. The dynamic resource controlling module 6012 may be an ARM chip.

In step 705, the dynamic resource controlling module calculates the number of required target processors based on the computing capacity of each of the processors and the monitored task amount.

A calculation result in this step may be obtained according to a calculation equation (1) as follows.

$$Y = ⌈ \frac{M}{N} ⌉$$

in which, Y denotes the number of the target processors, M denotes the task amount, and N denotes the computing capacity of each of the external processors.

In addition, a processing amount of each of the target processors may be calculated according to a calculation equation (2) as follows.

$$W = \frac{M}{Y}$$

in which, W denotes a processing amount of each of the target processors, M denotes the task amount, and Y denotes the number of the target processors.

The processing amount of each of the target processors is calculated according to the calculation equation (2), for equalized processing of the task, thereby ensuring processing efficiency of the task.

In addition, the task is allocated to each target processor based on the computing capacity of each of the processors.

In step 706, a route switching instruction is generated based on the calculated number of required target processors.

The route switching instruction generated in this step is used to control a communication line of the data link interacting module 6011 shown in FIG. 6. For example, in a case that the task A is allocated to the processors connected to the ports A11, A12 and A44, lines where the ports A11, A12 and A44 are located are connected based on the route switching instruction generated in this step, for data transmission between the server and the processor.

In step 707, the number of processors in a standby state is determined based on the usage state of each of the processors.

In step 708, it is determined whether the number of processors in the standby state is not less than the number of required target processors. The method goes to step 709 in a case that the number of processors in the standby state is not less than the number of required target processors, and the method goes to step 710 in a case that the number of processors in the standby state is less than the number of required target processors.

Whether to suspend processing of other processor subsequently is determined based on this step. In a case that the number of processors in the standby state is not less than the number of required target processors, the processors in the standby state can complete computing for the task A while processing of other processor is not suspended. In a case that the number of processors in the standby state is less than the number of required target processors, the processors in the standby state are insufficient to complete computing for the task A, and whether to suspend processing of other processor is further determined based on the priority level of the task A.

In step 709, at least one target processor is selected from the processors in the standby state based on the route switching instruction, and the task A is transmitted to the at least one target processor, the flow ends.

As shown in FIG. 6, in a case that the processors connected to the ports A11, A12, A33 and A44 are in a standby state, and only three processors are required for processing the task A, the dynamic resource controlling module 6012 may randomly allocate the task A to the processors connected to the ports A11, A12 and A44. That is, the dynamic resource controlling module 6012 generates a route switching instruction, and the task A is allocated to the processors connected to the ports A11, A12 and A44 in response to the route switching instruction in this step.

In step 710, in a case that the priority level of the task A is higher than a priority level of other task processed by the processors currently, processing of a part of the processors for other task is suspended.

For example, five target processors are required for processing the task A, and only four processors are in the standby state currently. In a case that a priority level of a task B processed by the processors currently is lower than the priority level of the task A, processing of any one processor for processing the task B is suspended, so that five target processors are available for processing the task A.

In step 711, the task A is allocated to the processor in the standby state and the processor, processing of which is suspended.

Based on the above solution, the embodiments of the present disclosure have at least the following advantageous effects.

1. The data link interacting module is connected to the external server, the at least two external processors and the dynamic resource controlling module. The dynamic resource controlling module is connected to the external server, and is configured to monitor a task amount of a to-be-allocated task carried by the external server, generate a route switching instruction based on the task amount, and transmit the route switching instruction to the data link interacting module. The data link interacting module is configured to receive the to-be-allocated task allocated by the external server and the route switching instruction transmitted by the dynamic resource controlling module, and transmit the to-be-allocated task to at least one target processor in response to the route switching instruction. A process of allocating a task to the processor is implemented by the data link interacting module, and the data link interacting module is connected to the server and the processor, so that a task and a task calculation result are transmitted between the server and the processor without data sharing over a network, thereby effectively reducing delay for resource scheduling.

2. As compared with the existing transmission over a network, the data is transmitted by the PCIE bus, thereby effectively improving timeliness and stability of data transmission.

3. The computing capacity of each of the external processors is determined, and the number of the target processors is calculated based on the computing capacity of each of the external processors and the monitored task amount, and a route switching instruction is generated based on the obtained usage state of each of the processors provided by the external server and the calculated number of target processors, such that the target processors are sufficient to process the task, thereby ensuring efficiency of processing the task.

4. A priority level of the to-be-allocated task carried by the server is monitored. In a case that the priority level of the to-be-allocated task is higher than a priority level of a currently run task, processing of the external processor for the currently run task is suspended in response to a suspending instruction, and the to-be-allocated task is transmitted to at least one target processor, thereby processing the task based on the priority level, and further ensuring computing performance.

It should be further noted that the relationship term such as “first”, “second” and the like are only used herein to distinguish one entity or operation from another entity or operation, rather than necessitating or implying that a relationship or an order exists between the entities or operations. Furthermore, terms “include”, “comprise” or any other variants are intended to be non-exclusive. Therefore, a process, a method, an article or a device including a series of factors includes not only the factors but also other factors that are not enumerated, or also include the factors inherent for the process, the method, the article or the device. Unless expressively limited otherwise, the statement “comprising (including) one . . . ” does not exclude a case that other similar factors may exist in the process, the method, the article or the device including the factors.

It can be understood by those skilled in the art that all or a part of steps for implementing the above method embodiment can be executed by instructing related hardware with programs. The above programs may be stored in a computer readable storage medium. The steps in the above method embodiment can be executed when executing the program. The above storage medium includes a ROM, a RAM, a magnetic disk, an optical disk or various medium which can store program codes.

Finally, it should be illustrated that only preferred embodiments of the present disclosure are described above, and are only intended to illustrate technical solutions of the present disclosure, rather than limiting the protection scope of the present disclosure. Any changes, equivalent replacement and modification made within the spirit and principle of the present disclosure should fall within the protection scope of the present disclosure.

1. A resource scheduling device, comprising:
a data link interacting module; and
a dynamic resource controlling module,
wherein the data link interacting module is connected to an external server, at least two external processors and the dynamic resource controlling module,
the dynamic resource controlling module is connected to the external server, and is configured to monitor a task amount of a to-be-allocated task carried by the external server, generate a route switching instruction based on the task amount, and transmit the route switching instruction to the data link interacting module, and
the data link interacting module is configured to receive the to-be-allocated task allocated by the external server and the route switching instruction transmitted by the dynamic resource controlling module, and transmit the to-be-allocated task to at least one target processor among the at least two external processors in response to the route switching instruction.

2. The resource scheduling device according to claim 1, wherein
the data link interacting module comprises a first FGPA chip, a second FPGA chip and a x16 bandwidth PCIE bus,
the first FPGA chip is configured to switch one channel of the x16 bandwidth PCIE bus to four channels,
the second FPGA chip is configured to switch the four channels to sixteen channels, and connect each channel of the sixteen channels to one of the external processors,
the dynamic resource controlling module is connected to the second FGPA chip, and is configured to transmit the route switching instruction to the second FPGA chip, and
the second FPGA chip is configured to select at least one task transmission link from the sixteen channels in response to the route switching instruction, and transmit the to-be-allocated task to the at least one target processor corresponding to the at least one task transmission link through the at least one task transmission link.

3. The resource scheduling device according to claim 1, wherein the dynamic resource controlling module comprises:
a calculating sub module; and
an instruction generating sub module,
wherein the calculating sub module is configured to determine computing capacity of each of the external processors, and calculate the number of the target processors based on the computing capacity of each of the external processors and the monitored task amount, and
the instruction generating sub module is configured to obtain a usage state of each of the processors provided by the external server, and generate the route switching instruction based on the usage state of the processor and the number of the target processors calculated by the calculating sub unit.

4. The resource scheduling device according to claim 3, wherein the calculating sub module is further configured to calculate the number of the target processors according to a calculation equation as follows:
$$Y = ⌈ \frac{M}{N} ⌉$$
wherein Y denotes the number of the target processors, M denotes the task amount, and N denotes the computing capacity of each of the external processors.

5. The resource scheduling device according to claim 1, wherein
the dynamic resource controlling module is further configured to monitor a priority level of the to-be-allocated task carried by the external server, and transmit a suspending instruction to the data link interacting module in a case that the priority level of the to-be-allocated task is higher than a priority level of a currently run task, and
the data link interacting module is further configured to suspend processing of the external processor for the currently run task upon receiving the suspending instruction, and transmit the to-be-allocated task to the at least one target processor.

6. A resource scheduling system, comprising:
a resource scheduling device comprising a data link interacting module and a dynamic resource controlling module,
wherein the data link interacting module is connected to an external server, at least two external processors and the dynamic resource controlling module,
the dynamic resource controlling module is connected to the external server, and is configured to monitor a task amount of a to-be-allocated task carried by the external server, generate a route switching instruction based on the task amount, and transmit the route switching instruction to the data link interacting module, and
the data link interacting module is configured to receive the to-be-allocated task allocated by the external server and the route switching instruction transmitted by the dynamic resource controlling module, and transmit the to-be-allocated task to at least one target processor among the at least two external processors in response to the route switching instruction;
a server; and
at least two processors,
wherein the server is configured to receive a to-be-allocated task inputted, and the resource scheduling device is configured to allocate the to-be-allocated task to at least one target processor among the at least two processors.

7. The resource scheduling system according to claim 6, wherein
the server is further configured to determine usage states of the at least two processors, and transmit the usage states of the at least two processors to the resource scheduling device, and
the resource scheduling device is configured to generate a route switching instruction based on the usage states of the at least two processors, and allocate the to-be-allocated task to at least one target processor among the at least two processors in response to the route switching instruction; and/or
the server is further configured to mark a priority level of the to-be-allocated task, and
the resource scheduling device is configured to obtain the priority level of the to-be-allocated task marked by the server, and configured to, in a case that the marked priority level of the to-be-allocated task is higher than a priority level of a currently run task processed by the processor, suspend processing of the processor for the currently run task and allocate the to-be-allocated task to the processor.

8. A resource scheduling method, comprising:
monitoring, by a dynamic resource controlling module, a task amount of a to-be-allocated task carried by an external server;
generating a route switching instruction based on the task amount, and transmitting the route switching instruction to a data link interacting module; and
transmitting, by the data link interacting module, the to-be-allocated task to at least one target processor in response to the route switching instruction.

9. The resource scheduling method according to claim 8, further comprising: determining, by the dynamic resource controlling module, computing capacity of each of processors;
wherein after the monitoring the task amount of the to-be-allocated task carried by the external server and before the generating the route switching instruction, the method further comprises: calculating the number of the target processors based on the computing capacity of each of the external processors and the monitored task amount, and obtaining a usage state of each of the processors provided by the external server, and
wherein the generating the route switching instruction comprises: generating the route switching instruction based on the usage state of each of the processors and the calculated number of the target processors.

10. The resource scheduling method according to claim 9, wherein the calculating the number of the target processors comprises calculating the number of the target processors according to a calculation equation as follows:
$$Y = ⌈ \frac{M}{N} ⌉$$
wherein Y denotes the number of the target processors, M denotes the task amount, and N denotes the computing capacity of each of the external processors.

11. The resource scheduling device according to claim 2, wherein the dynamic resource controlling module comprises:
a calculating sub module; and
an instruction generating sub module,
wherein the calculating sub module is configured to determine computing capacity of each of the external processors, and calculate the number of the target processors based on the computing capacity of each of the external processors and the monitored task amount, and
the instruction generating sub module is configured to obtain a usage state of each of the processors provided by the external server, and generate the route switching instruction based on the usage state of the processor and the number of the target processors calculated by the calculating sub unit.

12. The resource scheduling device according to claim 2, wherein
the dynamic resource controlling module is further configured to monitor a priority level of the to-be-allocated task carried by the external server, and transmit a suspending instruction to the data link interacting module in a case that the priority level of the to-be-allocated task is higher than a priority level of a currently run task, and
the data link interacting module is further configured to suspend processing of the external processor for the currently run task upon receiving the suspending instruction, and transmit the to-be-allocated task to the at least one target processor.

13. The resource scheduling device according to claim 3, wherein
the dynamic resource controlling module is further configured to monitor a priority level of the to-be-allocated task carried by the external server, and transmit a suspending instruction to the data link interacting module in a case that the priority level of the to-be-allocated task is higher than a priority level of a currently run task, and
the data link interacting module is further configured to suspend processing of the external processor for the currently run task upon receiving the suspending instruction, and transmit the to-be-allocated task to the at least one target processor.

14. The resource scheduling device according to claim 4, wherein
the dynamic resource controlling module is further configured to monitor a priority level of the to-be-allocated task carried by the external server, and transmit a suspending instruction to the data link interacting module in a case that the priority level of the to-be-allocated task is higher than a priority level of a currently run task, and
the data link interacting module is further configured to suspend processing of the external processor for the currently run task upon receiving the suspending instruction, and transmit the to-be-allocated task to the at least one target processor.

15. The resource scheduling system according to claim 6, wherein
the data link interacting module comprises a first FGPA chip, a second FPGA chip and a x16 bandwidth PCIE bus,
the first FPGA chip is configured to switch one channel of the x16 bandwidth PCIE bus to four channels,
the second FPGA chip is configured to switch the four channels to sixteen channels, and connect each channel of the sixteen channels to one of the external processors,
the dynamic resource controlling module is connected to the second FGPA chip, and is configured to transmit the route switching instruction to the second FPGA chip, and
the second FPGA chip is configured to select at least one task transmission link from the sixteen channels in response to the route switching instruction, and transmit the to-be-allocated task to the at least one target processor corresponding to the at least one task transmission link through the at least one task transmission link.

16. The resource scheduling system according to claim 6, wherein the dynamic resource controlling module comprises:
a calculating sub module; and
an instruction generating sub module,
wherein the calculating sub module is configured to determine computing capacity of each of the external processors, and calculate the number of the target processors based on the computing capacity of each of the external processors and the monitored task amount, and
the instruction generating sub module is configured to obtain a usage state of each of the processors provided by the external server, and generate the route switching instruction based on the usage state of the processor and the number of the target processors calculated by the calculating sub unit.

17. The resource scheduling system according to claim 16, wherein the calculating sub module is further configured to calculate the number of the target processors according to a calculation equation as follows:
$$Y = ⌈ \frac{M}{N} ⌉$$
wherein Y denotes the number of the target processors, M denotes the task amount, and N denotes the computing capacity of each of the external processors.

18. The resource scheduling system according to claim 6, wherein
the dynamic resource controlling module is further configured to monitor a priority level of the to-be-allocated task carried by the external server, and transmit a suspending instruction to the data link interacting module in a case that the priority level of the to-be-allocated task is higher than a priority level of a currently run task, and
the data link interacting module is further configured to suspend processing of the external processor for the currently run task upon receiving the suspending instruction, and transmit the to-be-allocated task to the at least one target processor.
